(19) United States
(12) Patent Application Publication
(10) Pub. No.: US 2022/0355863 A1
(43) Pub. Date: Nov. 10, 2022

(54) SENSOR APPARATUS FOR DETECTING THE ROTATION ANGLE POSITION OF A ROTATABLE SHAFT AND STEERING ARRANGEMENT OF A VEHICLE

(71) Applicant: Schaeffler Technologies AG & Co. KG, Herzogenaurch (DE)

(72) Inventors: Thomas LINDENMAYR, Nurnberg (DE); Matthias HINTZE, Dettendorf (DE); Ian BLAESER, Erlangen (DE)

(21) Appl. No.: 17/765,423

(22) PCT Filed: Sep. 11, 2020
(86) PCT No.: PCT/DE2020/100791

§ 371 Date: Mar. 30, 2022

(30) Foreign Application Priority Data
Oct. 10, 2019 (DE) 10 2019 127 297.1

(51) Int. Cl. B62D 15/02; G01D 5/20

(52) U.S. Cl. CPC B62D 15/0225; G01D 5/2053; G01D 2205/28

(57) ABSTRACT

A sensor apparatus (01) is for determining a rotation angle position of a rotatable shaft (02). The sensor apparatus (01) comprises a main gear wheel (03), which is coaxially coupled to the rotatable shaft (02), and a secondary gear wheel (04), which is arranged so as to be rotatably coupled on the main gear wheel (03). The sensor apparatus (01) furthermore comprises two targets (06, 07), each of which is arranged on a lateral face of the main gear wheel (03) or of the secondary gear wheel (04), and two rotation angle sensors (08, 09), which are arranged in the immediate vicinity of the main gear wheel (03) and the secondary gear wheel (04) on a circuit board (05). The angles of the main gear wheel (03) and of the secondary gear wheel (04) are determined and forwarded as an angular signal to an evaluating unit (10) arranged on the circuit board.

### CROSS-REFERENCE TO RELATED APPLICATIONS

This application is the U.S. National Phase of PCT Appln. No. PCT/DE2020/100791 filed Sep. 11, 2020, which claims priority to DE 10 2019 127 297.1, filed Oct. 10 2019, the entire disclosures of which are incorporated by reference herein.

### TECHNICAL FIELD

The present disclosure relates to a sensor apparatus for determining the rotation angle position of a rotatable shaft. The sensor apparatus can be used to determine a rotation angle position on a rotatable machine element, in particular on a steering element. The steering element is preferably part of a steering arrangement of a vehicle.

### BACKGROUND

A method for determining a rotation angle position is known from DE195 06 938 A1. The method described there is used in particular to determine the rotation angle position of a steering shaft of a motor vehicle, which is usually rotatable by more than 360°. The steering shaft represents a first rotatable body that cooperates with at least two further rotatable bodies, which are formed, for example, as gear wheels or gear rims. The angular position of the rotating bodies is determined by means of two sensors, which are connected to an electronic evaluation circuit that uses an algorithm to determine the actual angular position of the steering shaft. The number of teeth of the further rotatable bodies differs from the number of teeth of the first rotatable body, as a result of which a more accurate determination of the rotation angle is enabled.

From practice, rotation angle determining devices with sensor units are known, which are designed as potentiometers. These are subject to wear and are prone to failure. Furthermore, the measurement accuracy is limited to a few angular degrees. Sensor units based on a magnetic measuring principle can have a negative influence on one another, which can cause a distortion of the measurement result. Furthermore, magnetically acting sensors require at least one drive gear and at least two output gears to cover a measuring range of more than 360°. The signals obtained in this way are processed into a single angular signal using the vernier principle. The magnetically acting sensors are subject to hysteresis due to the magnetic bodies used. In addition, external magnetic fields can act as a source of interference and considerably influence measurement.

Sensor units are also known which use optical sensors and have, for example, an active photodiode and a passive optical scale. The measurement accuracy is limited by the accuracy of the optical scale. Manufacture is therefore expensive and the sensor units are sensitive to dirt and temperature. Furthermore, optical sensors require a comparatively large installation space.

Also known are rotation angle determining devices which use inductive sensors. According to the background of the art, a combination of several inductive sensors has not been successful so far, because the sensors influence one another in an undesirable manner.

A rotation angle determining device for determining the rotation angle position of a rotatable shaft is known from EP 2 180 296 A1, in particular for determining the rotation angle of a steering shaft or a rotatable shaft of a motor vehicle coupled thereto. The device includes a main rotor and an auxiliary rotor coupled to the main rotor. A first sensor unit is arranged on the main rotor, which is designed as an inductive sensor and has an induction rotor that rotates with the main rotor and a stationary stator. Furthermore, a second sensor unit is arranged on the auxiliary rotor and is designed as a magnetically acting sensor comprising a sensor element and a magnetic body, wherein the sensor element is designed to detect a movement of the magnetic body.

In a patent application of the applicant not yet published at the time of application, a sensor arrangement for detecting a steering torque and an absolute angular position of a steering element extending along an axis is described, which comprises a first sensor element for determining the steering torque and a second sensor element for determining the absolute angular position. The second sensor element comprises two rotation angle sensors and at least two gear wheels acting together as a mechanical reduction, wherein these form a target on one of their lateral faces in each case. The first target is formed in the shape of a semicircle and the second target is divided into segments of a circle and thus has a different effective area around its circumference. The semicircular geometry of the target causes a sine/cosine signal to be generated when the steering element is rotated, which can be detected by the rotation angle sensor. Using the sine/cosine signal, an absolute angle from 0° to 360° can be determined using the arc tangent.

### SUMMARY

Based on the present background of the art, one object of the present disclosure is to provide a purely inductive sensor apparatus for determining a rotation angle position of a rotatable shaft, in particular a steering shaft of a vehicle. Furthermore, an improved steering arrangement of a vehicle with such a sensor apparatus is to be provided.

Said object is achieved by a sensor apparatus for measuring the rotation angle position on a rotatable shaft according to the present disclosure.

The sensor apparatus according to the present disclosure is used to determine the rotation angle position of a rotatable shaft. The rotatable shaft is, for example, a steering rod or steering shaft or part of a steering wheel of a motor vehicle. In particular, the sensor arrangement is used to determine the rotation angle position for a multi-turn of the rotatable shaft, i.e. for a rotation greater than one or exceeding 360°. Often, the usual steering distances allow at least 2.5 revolutions, starting from a zero position in each direction, or a rotation angle of −/+900°. For determining the rotation angle position, the sensor apparatus comprises a main gear wheel which can be coupled coaxially to the rotatable shaft and on which a first target is arranged for determining the angular position of the main gear wheel. Furthermore, the sensor apparatus comprises a secondary gear wheel, which forms a gear with the main gear wheel, i.e., the two gear wheels mesh with one another and rotate in opposite directions. A second target is also arranged on the secondary gear wheel to determine its angular position. Furthermore, the sensor apparatus comprises a circuit board which lies parallel to the main extension plane of the two gear wheels and is arranged to be non-rotatable and/or fixed to the housing. Preferably, the circuit board is formed in the shape of a disk and has a shaft passage through which the rotatable shaft can be rotatably guided. This favors a space-saving arrangement. Furthermore, the sensor apparatus comprises at least two rotation angle sensors, which are arranged opposite the targets on the circuit board, and an evaluating unit, which is preferably also mounted on the circuit board and receives the angular signals supplied by the rotation angle sensors and uses them to calculate the absolute rotation angle position of the main gear wheel and the secondary gear wheel and the rotation angle position of the rotatable shaft coupled to the main gear wheel.

The targets extend over an angular portion of 180° on each of the lateral faces of the main gear wheel and the secondary gear wheel, so that the rotation angle sensors, each fed by an excitation current, can determine the angular position of both gears. Preferably, the targets are attached to or integrated into the surface of the respective gear wheel in the manner of a ring section. The two rotation angle sensors are designed as inductive sensors, which are operated with excitation currents whose frequencies differ. This suppresses mutual interference of excitation currents of the two sensors, which allows for a more accurate determination of the rotation angles.

Preferably, the rotation angle sensors are designed as a coil arrangement on the circuit board, wherein each rotation angle sensor has at least one excitation coil and two receiver coils connected in opposite directions. The excitation coil generates a magnetic field which changes over time and induces voltages in the two opposing receiver coils which cancel each other out if there is no electrically conductive object in the effective range of the excitation coil. However, if there is an electrically conductive object in the effective range of the excitation coil, i.e., the target on one of the two gear wheels, eddy currents are induced in this object, which generate a field directed in the opposite direction to the excitation field. This causes deviating induction voltages in the two receiver coils in opposite directions. The voltage ratio of the target can be used to determine the position of the target and thus the angular position of the respective gear wheel.

To allow for inductive detection, the targets, which extend over an angular portion of 180°, exhibit an electrical conductivity so that the angular position of the main gear wheel and secondary gear wheel can be determined based on voltage changes induced in the rotation angle sensors.

Preferably, a bandpass filter is coupled to each rotation angle sensor to extract only the desired frequency or a very narrow frequency band for further signal processing so that noise immunity regarding other frequencies is increased. This ensures operation of the rotation angle sensors with differing frequencies.

Preferably, the first partly annular target has a larger radius than the second partly annular target and is thus arranged radially further outside on the main gear wheel, while the second target is arranged radially further inside on the additional gear wheel. Likewise, the arrangements and radii can be selected oppositely. As a result, there is an increased distance between the targets even in the region where the gear wheels touch or their teeth mesh, so that neither of the targets is in the inductive effective range of the other target, which suppresses mutual interference and enables precise determination of the rotation angle.

Preferably, the number of teeth of the two additional bodies differs by one tooth so that the vernier principle can be applied. Using this principle, it is possible to increase the accuracy of determining the rotation angle position of the main gear wheel and the shaft coupled to it.

Preferably, the main gear wheel and secondary gear wheel can be made of plastic, thus avoiding the influence of electrically conductive materials within the effective range of the excitation coil other than the targets. Preferably, the targets can be embedded in the main or secondary gear wheel, wherein the targets are embedded flush with the surface, for example. Alternatively, they can also be arranged such that they are completely surrounded by plastic. Particularly in combination with gear wheels made of plastic, this permits a simplified design and, above all, simplified production.

The steering arrangement according to the present disclosure comprises a rotatable shaft and a sensor apparatus coupled to the rotatable shaft according to the sensor apparatus described above with all its embodiments. The rotatable shaft thus carries the main gear wheel of the sensor arrangement and is preferably part of a steering system of a vehicle. Particularly preferably, the steering system is an electro-mechanical power steering system.

### BRIEF SUMMARY OF THE DRAWINGS

Further details, advantages and further embodiments of the present disclosure can be found in the following description, in which the present disclosure is described and explained in more detail with reference to the exemplary embodiment shown in the drawing. In the figures:

FIG. 1 shows a side view of an exemplary embodiment of a sensor apparatus according to the present disclosure;

FIG. 2 shows a top view of the sensor apparatus;

FIG. 3 shows a detailed view of a main gear wheel and a secondary gear wheel of the sensor apparatus.

### DETAILED DESCRIPTION

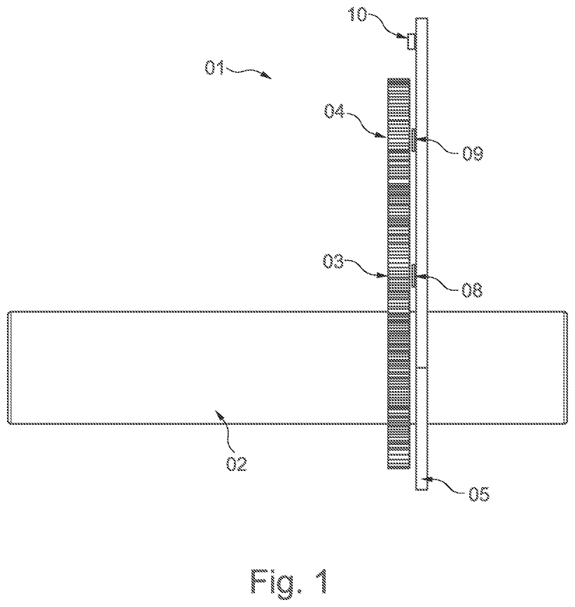

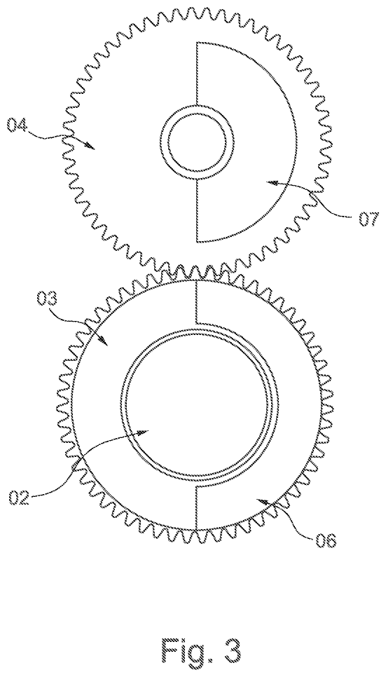

FIG. 1 shows an exemplary embodiment of a sensor apparatus 01 according to the present disclosure. The sensor apparatus 01 is used to determine the rotation angle position of a rotatable shaft 02, which can be part of an electro-mechanical steering system and is in particular a steering shaft. When the sensor apparatus is installed, a main gear wheel 03 of the sensor apparatus is arranged on this steering shaft 02 in the form of a toothed encoder wheel which rotates with the rotatable shaft 02. A rotatably coupled secondary gear wheel 04 in the form of a toothed vernier gear is arranged on this main gear wheel 03, which is caused to rotate by the main gear wheel 03. It is possible to design the main gear wheel 03 with a larger diameter than the secondary gear wheel 04, whereby the secondary gear wheel 04 experiences a higher rotational speed than the main gear wheel 03. Alternatively, the spatial arrangement of the secondary gear wheel 04 on the main gear wheel 03 can differ from the arrangement in FIG. 1. The main gear wheel 03 and the secondary gear wheel 04 have a different number of teeth in order to be able to apply the vernier principle. This also enables the rotation angle to be determined over a rotation range of more than 360°. Furthermore, a first target 06 is arranged on the main gear wheel 03 and a second target 07 on the secondary gear wheel 04 (see FIG. 3), which serve to determine the rotation angle of the gears. Opposite the targets 06, 07, a first rotation angle sensor 08 and a second rotation angle sensor 09 are arranged on a circuit board 05, which detect the movement of the targets and generate an angular signal in each case. An evaluating unit 10, which is also located on the circuit board 05, receives the angular signals and uses them to calculate the absolute rotation angle position of the steering shaft 02. The evaluating unit 10 is preferably a micro-controller which is mounted on the circuit board together with other electronic components.

The disk-shaped circuit board 05 extends substantially perpendicular to the axis of the steering shaft 02. If necessary, the circuit board 05 can also serve as a rotatable bearing for the steering shaft 02.

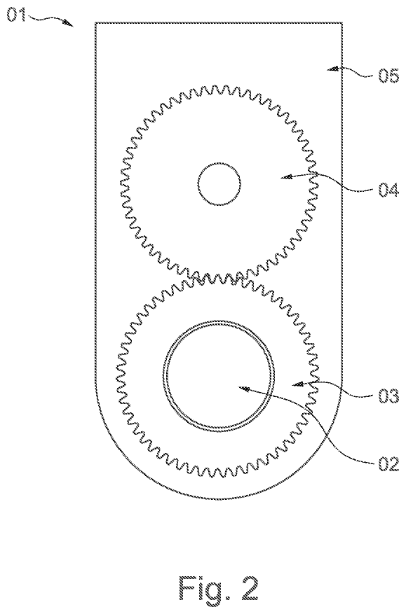

FIG. 2 shows a top view of the sensor apparatus 01. The circuit board 05 has a shaft passage through which the steering shaft 02 is guided. In a manner not shown further, the circuit board 05 is arranged in a non-rotatable manner; this can be realized, for example, by a fastening to the housing or by a bearing on the steering shaft 02. Furthermore, the arrangement of the main gear wheel 03 and the secondary gear wheel 04 is shown.

FIG. 3 shows the side of the main gear wheel 03 and secondary gear wheel 04 facing the circuit board 05. The target 06 and 07 is arranged on each side respectively, which each cover an annular portion and extend over an angular portion of about 180°. These targets 06, 07 are spaced apart from one another so that mutual interference is reduced. Preferably, the targets 06, 07 are embedded flush with the surface of the main gear wheel 03 or the secondary gear wheel 04.

### LIST OF REFERENCE NUMERALS

01 Sensor apparatus
02 Rotatable shaft
03 Main gear wheel
04 Secondary gear wheel
05 Circuit board
06 First target
07 Second target
08 First rotation angle sensor
09 Second rotation angle sensor
10 Evaluating unit

What is claimed is:

1. A sensor apparatus for determining a rotation angle position of a rotatable shaft which is rotatable by at least −/+360° starting from a zero position, the sensor apparatus comprising:
a main gear wheel configured for being coaxially coupled to the rotatable shaft and on which a first electrically conductive target is arranged;
a secondary gear wheel which engages in a gear-like manner in the main gear wheel and on which a second electrically conductive target is arranged;
a circuit board, which lies parallel to a main extension plane of the main gear wheel and the secondary gear wheel, is arranged in a non-rotatable manner, has a shaft passage through which the rotatable shaft is rotatably guidable, and which carries at least two rotation angle sensors each of which lies opposite a respective one of the first and second electrically conductive targets; and
an evaluating unit configured for receiving angular signals supplied by the at least two rotation angle sensors and determining the rotation angle position of the rotatable shaft therefrom;
the first electrically conductive target extending over an angular portion of 180° on a lateral face of the main gear wheel, the second electrically conductive target extending over an angular portion of 180° on a lateral face of the secondary gear wheel, the at least two rotation angle sensors being inductive sensors each supplied with an excitation current, a first excitation current for exciting the rotation angle sensor detecting the first electrically conductive target having a different frequency than a second excitation current for exciting the rotation angle sensor detecting the second electrically conductive target.

2. The sensor apparatus according to claim 1, wherein a number of teeth of the main gear wheel and the secondary gear wheel differs by one tooth so that a determination of the rotation angle position of the rotatable shaft can be performed according to the vernier principle.

3. The sensor apparatus according to claim 1, wherein that the first target has a different radius than the second target.

4. The sensor apparatus according to claim 1, wherein the first electrically conductive target is arranged radially outward on the main gear wheel.

5. The sensor apparatus according to claim 1, wherein the second electrically conductive target is arranged radially inward on the secondary gear wheel.

6. The sensor apparatus according to claim 1, wherein rotation angle sensors are provided as coil arrangements on the circuit board.

7. The sensor apparatus according to claim 6, wherein each of the at least two rotation angle sensors has an excitation coil and two receiver coils connected in opposite directions.

8. The sensor apparatus according to claim 1, wherein the main gear wheel and the secondary gear wheel are made of plastic.

9. The sensor apparatus according to claim 1, wherein the first and second electronically conductive targets are each embedded flush with a surface in a lateral face, opposite the circuit board, of the main gear wheel or the secondary gear wheel.

10. A steering arrangement of a vehicle comprising:
a rotatable shaft; and
the sensor apparatus according to claim 1 arranged on the rotatable shaft.

11. A method of constructing a sensor apparatus for determining a rotation angle position of a rotatable shaft which is rotatable by at least −/+360° starting from a zero position, the method comprising:
arranging a first electrically conductive target on a main gear wheel configured for being coaxially coupled to the rotatable shaft;
arranging a second electrically conductive target on a secondary gear wheel which engages in a gear-like manner in the main gear wheel;
non-rotatably providing a circuit board parallel to a main extension plane of the main gear wheel and the secondary gear wheel such that a first rotation angle sensor on the circuit board is opposite the first electrically conductive target and a second rotation angle sensor on the circuit board is opposite the second electrically conductive target; and
providing an evaluating unit configured for receiving angular signals supplied by the first and second rotation angle sensors and determining the rotation angle position of the rotatable shaft therefrom, the first and second rotation angle sensors being inductive sensors, the first rotation angle sensor configured for being operated with a first excitation current for exciting the first rotation angle sensor, the second rotation angle sensor configured for being operated with a second excitation current for exciting the second rotation angle sensor, the first excitation current being different from the second excitation current.

12. A sensor apparatus for determining a rotation angle position of a rotatable shaft which is rotatable by at least −/+360° starting from a zero position, the sensor apparatus comprising:
a main gear wheel configured for being coaxially coupled to the rotatable shaft, the main gear wheel supporting a first electrically conductive target;
a secondary gear wheel engaging the main gear wheel, the secondary gear wheel supporting a second electrically conductive target;
a circuit board arranged in a non-rotatable manner parallel to a main extension plane of the main gear wheel and the secondary gear wheel, the circuit board supporting a first rotation angle sensor opposite the first electrically conductive target and a second rotation angle sensor opposite the second electrically conductive target; and
an evaluating unit configured for receiving angular signals supplied by the first and second rotation angle sensors and determining the rotation angle position of the rotatable shaft therefrom, the first and second rotation angle sensors being inductive sensors, the first rotation angle sensor configured for being operated with a first excitation current for exciting the first rotation angle sensor, the second rotation angle sensor configured for being operated with a second excitation current for exciting the second rotation angle sensor, the first excitation current being different from the second excitation current.

13. The sensor apparatus according to claim 12, wherein the first and second electrically conductive targets are each ring sections.

14. The sensor apparatus according to claim 13, wherein the first electrically conductive target extends over an angular portion of 180° on a lateral face of the main gear wheel, the second electrically conductive target extending over an angular portion of 180° on a lateral face of the secondary gear wheel.

15. The sensor apparatus according to claim 12, wherein the first and second rotation angle sensors each have an excitation coil and two opposing receiver coils connected in opposite directions.

16. The sensor apparatus according to claim 15, wherein for each of the first and second rotation angle sensors, the excitation coil is configured for generating a magnetic field which changes over time and induces voltages in the two opposing receiver coils which cancel each other out if there is no electrically conductive object in an effective range of the excitation coil.

17. The sensor apparatus according to claim 16, wherein for each of the first and second rotation angle sensors, if a respective one of the first and second electrically conductive targets is in the effective range of the excitation coil, eddy currents are induced in the respective first or second electrically conductive target, which generate the magnetic field in an opposite direction to an excitation field causing deviating induction voltages in the two receiver coils in opposite directions, and a voltage ratio of the respective first or second electrically conductive target being usable by the evaluating unit to determine a position of the respective first or second electrically conductive target and an angular position of a respective one of the main or secondary gear wheel.

18. The sensor apparatus according to claim 12, further comprising a first bandpass filter coupled to the first rotation angle sensor configured to extract only a first desired frequency for further signal processing and a second bandpass filter coupled to the second rotation angle sensor configured to extract only a second desired frequency for further signal processing.

19. The sensor apparatus according to claim 12, wherein the sensor apparatus is a purely inductive sensor apparatus for determining the rotation angle position of the rotatable shaft.
